(19) United States
(12) Patent Application Publication
(10) Pub. No.: US 2017/0243298 A1
(43) Pub. Date: Aug. 24, 2017

(54) METHOD AND DEVICE FOR DETERMINING PREMIUM RATES AND DISCOUNTS FOR INSURANCE CUSTOMERS

(71) Applicant: ADACTA International LTD, Nicosia (CY)

(72) Inventor: Tomaz VOLK, Ljubljana (SI)

(21) Appl. No.: 15/051,157

(22) Filed: Feb. 23, 2016

(51) Int. Cl. G06Q 40/08; G06Q 30/02; G06Q 50/00; G06Q 10/10

(52) U.S. Cl. CPC G06Q 40/08; G06Q 10/10; G06Q 30/0239; G06Q 50/01

(57) ABSTRACT

A method and computer system for the assessment of the risk profile of insurance customers and for the segmentation of insurance customers into risk groups is provided. The method and computer system may particularly take into account mutual recommendations among existing and potential customers and the willingness of customers to possibly backup potential claims of certain other customers through a financial guarantee or bet.

### BACKGROUND

Insurance policies typically include legal agreements that specify items to be afforded coverage with respect to particular perils. For such agreements, numerous conditions apply, such as applicable deductibles, coverage limits, and the like, wherein related expense/billing can further be broken down into elements by covered item and peril.

Moreover, insurance carriers often view such policies as being derived from and related to a “policy product”. Typically, a policy product defines the attributes and shared data for its derived policies, wherein a process of writing a specific policy involves referring to the available attributes of the policy as defined by the policy product and the corresponding selection of appropriate values for a given customer. As such, coverage typically comprises an obligation to pay for damages that are caused by a particular peril (or collection of perils). Such obligation typically has corresponding financial limits and deductibles that circumscribe the insurer's responsibility for losses against that coverage. For example, a policy's total cost is usually determined as a function of the aggregate cost of the policy's constituent coverage sections.

Insurance premiums are typically fixed in price and billed in monthly, semi-annual, or annual time periods. Premiums can be affected by many policy parameters for which cost is averaged and can be adjusted for a given billing period. For example, with respect to automobile insurance, rates can be determined based on desired coverage level, automobile make, model, and color, automobile features, estimated miles driven each year, zip code, and the like. In addition, rates can be evaluated at the end of a premium period based on number of claims filed in the primary zip code. With such speculative and broad premium computation, it can become difficult to offer precise and competitive rates for insurance policies, hence hindering insurance markets.

An insurance company determines insurance costs based on insurance models that classify segments of the population to groups sharing similar data, such as but not limited to: age range, sex, marital status, residence, driving record, and the like. For each segment, the insurance model then employs a “one size fit” for all members, with no further differentiation. Nonetheless, such approach fails to consider additional variances that exist between members in same category, and hence squanders valuable data related to each individual's unique traits that can further affect respective insurance rates.

The present invention aims at providing a method and computer system to assess a customer's individual credibility and risk profile.

### SUMMARY

According to a first aspect a method for determining premium rates and discounts for insurance customers is provided. The method comprises receiving scans and/or photographs of documents and/or social network data from at least one first customer, said scans and photographs of documents being reflective of the risk profile said at least one first customer; collecting answers of an interactive questionnaire, said questionnaire concerning the risk profile of said at least one first customer; obtaining a first data set being reflective of said at least one first customer risk profile by combining said scans and/or photographs of documents and social network data and said answers; storing said first data set being reflective of said at least one first customer risk profile; obtaining suggestions for at least one second customer from said at least one first customer; receiving scans and/or photographs of documents and/or social network data from said at least one second customer, said scans and photographs of documents and/or social network data being reflective of the risk profile said at least one second customer; collecting answers of an interactive questionnaire, said questionnaire concerning the risk profile of said at least one second customer; obtaining a second data set being reflective of said at least one second customer risk profile by combining said scans and/or photographs of documents and/or social network data and said answers; storing said second data set being reflective of said at least one second customer risk profile; and calculating premium rates and discounts for the at least one first customer and the at least one second customer based on an analysis of said stored first and second data sets.

According to a further aspect the method comprises obtaining suggestions for an additional at least third customer from said at least one second customer.

According to a another aspect the method said stored second data set further comprises a number of suggestions for said at least one second customer; wherein the calculation of premium rates and discounts takes into account said number of suggestions.

According to a further aspect the analysis of said stored first and second data sets comprises optical character recognition (OCR) of the scanned and/or photographed documents and/or an analysis of social network data.

According to another aspect the method comprises offering said at least one first customer a discount or another future payment in return for said at least one first customer's participation in potential insurance claims of said at least one second customer; wherein said stored first and second data sets comprise information of the accepted offers; and wherein the calculation of premium rates and discounts takes into account said information of the accepted offers.

According to a further aspect the method comprises offering a person different from said at least one first customer and different from said at least one second customer a future payment in return for said person's participation in potential insurance claims of said at least one first customer or of said at least one second customer; wherein said stored first and second data sets comprise information of the accepted offers; and wherein the calculation of premium rates and discounts takes into account said information of the accepted offers.

According to a further aspect said person is already a customer and said future payment comprises a discount.

According to an aspect the method comprises offering an insurance policy to said at least one second customer.

According to a further aspect the method comprises determining a segmentation of said at least one second customer into different risk classes based on said stored first and second data sets and on the calculated premium rates and discounts.

According to another aspect the method comprises offering an insurance policy to said at least one second customer based on the risk class of the at least one second customer, with risk classification assisted by the fact that the at least one first customer was willing to recommend the at least one second customer, thereby making the at least one second customer more desirable to the insurance company.

According to a further aspect of the present invention a computer system for determining premium rates and discounts for insurance customers is provided, wherein the computer system comprises a device, which comprises a processing unit, a memory connected to said processing unit and a connection to the internet; a database connected to said device; wherein the device is configured to receive scans and/or photographs of documents and/or social network data from at least one first customer over the internet, said scans and photographs of documents and/or social network data being reflective of the risk profile said at least one first customer; collect answers of an interactive questionnaire, said questionnaire concerning the risk profile of said at least one first customer; obtain a first data set being reflective of said at least one first customer risk profile by combining said scans and/or photographs of documents and/or social network data and said answers; store said first data set being reflective of said at least one first customer risk profile in the database; obtain suggestions for at least one second customer from said at least one first customer; receive scans and/or photographs of documents and/or social network data from said at least one second customer over the internet, said scans and photographs of documents being reflective of the risk profile said at least one second customer; collect answers of an interactive questionnaire, said questionnaire concerning the risk profile of said at least one second customer; obtain a second data set being reflective of said at least one second customer risk profile by combining said scans and/or photographs of documents and/or social network data and said answers; store said second data set being reflective of said at least one second customer risk profile in the database; calculate premium rates and discounts for the at least one first customer and the at least one second customer based on an analysis of said stored first and second data sets.

### BRIEF DESCRIPTION OF THE DRAWINGS

FIG. 1 illustrates an exemplary block diagram of the method for determining premium rates and discounts for insurance customers.

FIG. 2 illustrates the computer system and its interaction with the customer, existing customers and potential new customers.

### DETAILED DESCRIPTION

The various aspects of the invention are now described with reference to the drawings. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

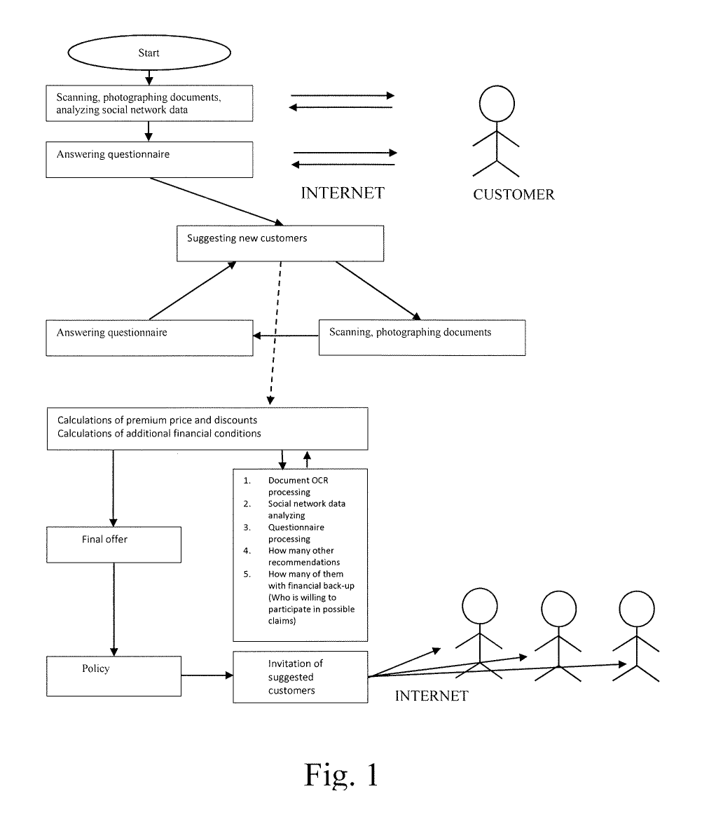

FIG. 1 illustrates an exemplary method that customizes insurance rates based on an assessment of the risk profile and credibility of customers. In a first step it is envisaged and contemplated to receive scans and photographs of documents and/or social network data of at least one first customer. These documents should be indicative of the at least one first customers risk profile. For example in the case of a motor vehicle insurance, i.e. MTPL (Motor Third Party Liability) insurance and/or COMPREHENSIVE insurance, the documents might include gender, age and driving history of the driver and a classification of the vehicle, e.g. performance capability or retail cost.

Furthermore, the at least one first customer may be required to answer a questionnaire. The questions and the answers thereto should further facilitate the assessment of the risk profile of the customer. For example in the case of a motor vehicle insurance the customers driving behavior might be of interest. In the case of life insurance the customer's general lifestyle might be of interest. The questions asked may partly be based on the scanned/photographed documents and/or social network data.

This whole process of receiving documents and/or social network data and questioning the customer can be done interactively over the internet using a web frontend or mobile phone app (or using other channels). Of course, the customer may be required to provide evidence of the authenticity of the scans/photographs. The selection of questions is partly done by a computer system in response to the scans/photographs of documents, which may be analyzed using OCR (optical character recognition) and possibly a software for image recognition. Special algorithms are used to analyze social network data. Further, since the questionnaire is interactive the questions may be selected in response to already given answers.

In a next step the at least one first customer is further invited to suggest at least one second customer and provide documents reflective of the at least one second customers risk profile, if possible. Similar to the process for the at least one first customer scans and/or photographs of documents of and/or social network data the suggested at least one second customer are then received via the internet. As above the new clients are required to answer an interactive questionnaire, which is partly based on the received documents and previously given answers. Overall the scans/photographs of documents and/or social network data and the answers to the questionnaire should be reflective of the credibility and risk profile of the at least one second customer. That the at least one second customer was suggested by the at least one first customer is considered a recommendation being indicative of a low risk profile. For example in the case of a motor vehicle insurance the at least one first customer might know the driving behavior of the at least one second customer and the recommendation be based on the at least one first customers observation that the at least one second customer is a careful driver.

An iteration of this process is possible, i.e. the suggested at least one second customer can suggest further third customers, which in turn provide scans/photographs of documents and/or social network data and answers to a questionnaire that are indicative of their risk profile. The result is a pool of proposed second customers, wherein a suggestion is taken as a measure for the credibility and a low risk of an at least one second customer.

Thus data sets reflective of the risk profile are obtained for the at least one first customer and for the suggested at least one second customer. The data sets contain information about the received scans/photographs of documents and/or social network data, the obtained answers to the questionnaire and also about the suggestions, which means how often was the at least one second customer suggested and who suggested the at least one second customer.

A further step comprises asking the at least one first customer to financially backup the suggestion/recommendation of the at least one second customer with some future obligation that a certain amount has to be paid in case claims being paid out to the suggested at least one second customer. In return the at least one first customer may be offered a discount resulting in a lower premium rate. The amounts of the future obligation and of the discount are calculated based on internal algorithms by the computer system.

The willingness of the at least one first customer to accept a financial obligation provides the recommendation with more weight. In particular, it is a reliable indicator for a low risk profile and credibility of the suggested at least one second customer, since the suggesting at least one first customer is not motivated to suggest bad customers, because he/she might lose money this way.

Again an iteration is possible, that is, the at least one second customer can be asked to possibly backup potential claims of other customers in return for a discount or other payments. All this information is included into the respective data sets.

The recommendation process may also be applied in reverse, in that said at least one first customer, when making the application for insurance coverage, asks another person (or persons) to recommend said at least one first customer by backing up this recommendation through a financial obligation.

This reverse recommendation process may also be applied in further iterations, that is, the at least one second customer may ask another person (or persons) to provide a recommendation and back up this recommendation through a financial obligation.

More generally, any customer can be asked to financially backup any other customer or any other potential customer with some future obligation that a certain amount has to be paid in case claims are being paid out to that other customer/potential customer. The customer could be offered a discount or other (future) payment, if he/she backs up some other customer/potential customer. In this way valuable information about the risk profiles of the customers/potential customers is obtained.

The method integrates the collected information comprising scans/photographs of documents and/or social data network, answers to the questionnaires, data about the suggestions and data about potential financial backup into data sets being reflective of the risk profiles of the at least one first customer and the at least one second customer.

Calculations of premium rates, discounts and of additional financial conditions are carried out by an algorithm on basis of said data sets reflective of the risk profiles of the at least one first customer and the at least one second customer. In this way the calculation takes into account the received documents and/or social network data, the questionnaire, the amount of recommendations and the amount of financial backup. A part of the calculations comprises processing the scans/photographs of documents and/or social network data and the answers to the questionnaire.

A key feature of the present invention is that the algorithm to calculate the premium rates and discounts further considers the number of recommendations made for said at least one second customer and the number of customers willing to participate in potential claims. In particular, the amount of possible financial backup is a good indicator for the risk profile and credibility of the at least one second customer, since the recommending at least one first customer is willing to cover some financial which indicates that said at least one first customer possesses some knowledge concerning the risk profile of the at least one second customer. The method thus allows a further segmentation of insurance customers according to their risk profile into risk groups in addition to the usual segmentation according to age range, sex, marital status, residence, driving record, and the like.

Furthermore said at least one first customer can be asked if he/she is willing to place a bet (or to guarantee in a way that he/she participates in deductible in claims) that the suggested at least one second customer will not have any claims during a certain period of time or that the at least one second customer will not have any claims above a certain amount during a certain period of time. All conditions of this bet are calculated by an algorithm in a way to maximize the precision of the method's risk assessment of customers.

This can be extended by also offering bets to the at least one second customer. That is, to ask the at least one second customer to place a bet on whether or not a specific customer will have any claims during a certain period of time or that the customer will not have any claims above a certain amount during a certain period of time. Further, this offering of bets can be extended to all existing customers of the insurance company. In yet another extension the computer algorithm can be made in such a way that any person can bet on any other person. For example, a bank can bet on their specific customers and can by doing this offer them insurance discounts. A company can bet on one or more of their employees to offer them insurance discounts.

In a last step the conditions of insurance policies are determined based on the calculated premium rates and discounts. These policies are then offered said at least one second customer. The decision to offer said at least one second customer can further depend on the at least on second customer's risk class which was determined by the method. For example if the at least one second customer belongs to a group with generally high risk, the algorithm could decide to not offer the at least one second customer an insurance policy at all, in order to keep the overall risk exposure of the insurance company low.

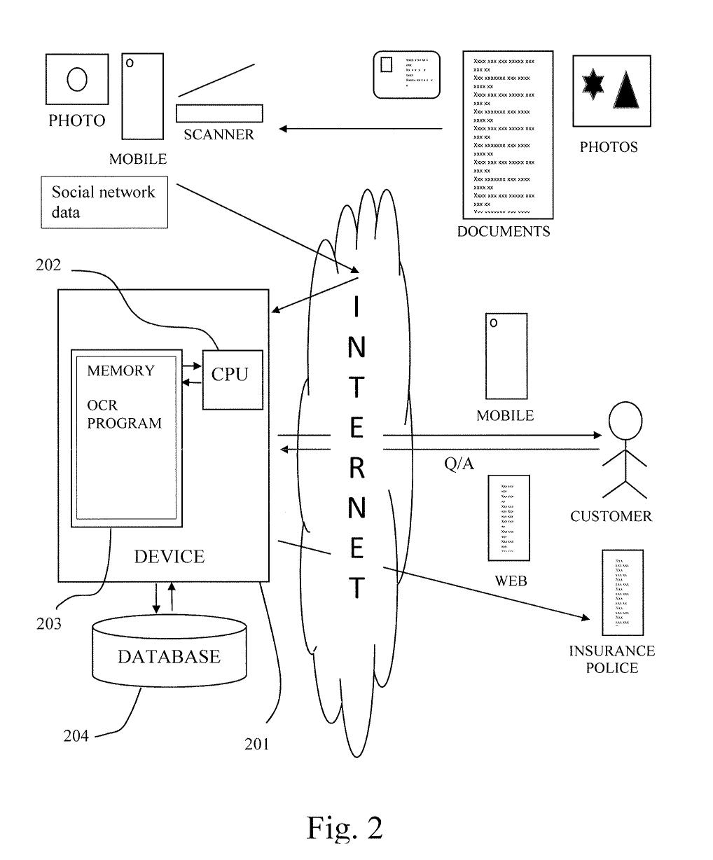

FIG. 2 illustrates a computer system that implements the method for the segmentation of insurance customers. The computer system comprises a device 201 that includes a processing unit (CPU) 202 and a memory 203 for storing the software programs that carry out the algorithms. Said device is connected to a database 204 and to the internet, which enables the device 201 to communicate with the customers in order to receive data and to store said data in the database 204. An analysis of the risk profiles of the customers is then carried out on the basis of the stored data.

Over the internet the device 201 receives scans and/or photographs of documents and/or social network data from at least one first customer, said scans and photographs of documents being reflective of the risk profile of said at least one first customer, it further collects answers of an interactive questionnaire, said questionnaire concerning the risk profile of said at least one first customer. In this way a first data set is obtained, said first data set being reflective of said at least one first customer risk profile. The device stores said first data set being reflective of said at least one first customer risk profile in the database 204.

The device can collect suggestions for an at least one second customer from said at least one first customer. For the at least one second customer the device then obtains and stores a second data set being reflective of the risk profile of said at least one second customer. In particular, scans/photographs of documents and answers to an interactive questionnaire are received via the internet. The obtained information is reflective of the at least one second customer's risk profile and credibility.

Based on the data collected that far the device 201 can then decide to ask the at least one first customer if he/she is willing to financially backup potential claims of the at least one second customer in return for discount and/or some other future payment. The same procedure is taken for any third party willing to recommend/backup said at least one second customer. Accordingly a plurality of customers can be chosen.

The information concerning suggestions/recommendations and possible financial backup is integrated in the respective first and second data sets and stored in the database 204. Of course the data sets also comprise information about age, sex, marital status, residence, driving record, etc of the customers, which are commonly used in the assessment of a customer's insurance risk. In this way the data sets stored in the database contain all information relevant for determining the risk profiles of the customers.

Parts of the collected data, i.e. the scans/photographs of documents and/or social network data, may further be analyzed by the device 201 using optical character recognition and image recognition programs, in order to extract information concerning the risk profile of the at least one first and at least one second customers. This information is then also stored in the respective data sets.

Based on the at least one first data and the at least one second sets stored in the database 204 and reflective of the risk profiles of the at least one first and the at least one second customers the device calculates premium rates and discounts for the at least one first customer and the at least one second customer. To that end the device 201 utilizes an algorithm stored in the memory 203 of the device 201. Furthermore, based on the complete data about the entirety of customers contained in said data sets the algorithm might determine a segmentation of said customers into different risk classes. In particular, the algorithm takes into account the recommendations of customers and the willingness to financially backup potential claims.

The device 201 determines the premium rates, discounts and further conditions of the insurance policies that are offered to the customers. This process is based on the risk analysis done by the device and may also take into consideration the overall risk an insurance carrier is willing to take.

What is claimed is:

1. A processor-implemented method for determining premium rates and discounts for insurance customers comprising:
receiving, by a processing device, scans and/or photographs of documents from at least one first customer, and/or obtaining social network data about said at least one first customer, said scans and/or photographs of documents and/or said social network data being reflective of a risk profile of said at least one first customer;
providing, by the processing device, an interactive questionnaire to said at least one first customer, said questionnaire concerning the risk profile of said at least one first customer, and receiving one or more answers from said at least one first customer;
obtaining, by the processing device, a first data set being reflective of said at least one first customer's risk profile by combining and/or integrating said scans and/or photographs of documents received from said at least one first customer and/or said social network data about said at least one first customer and said answers received from said at least one first customer;
storing said first data set in a database;
obtaining, by the processing device, suggestions for at least one second customer from said at least one first customer;
receiving, by the processing device, scans and/or photographs of documents from said at least one second customer and/or obtaining social network data about said at least one second customer, said scans and/or photographs of documents and/or said social network data being reflective of a risk profile of said at least one second customer;
providing, by the processing device, an interactive questionnaire to said at least one second customer, said questionnaire concerning the risk profile of said at least one second customer, and receiving one or more answers from said at least one second customer;
obtaining, by the processing device, a second data set being reflective of said at least one second customer's risk profile by combining and/or integrating said scans and/or photographs of documents received from said at least one second customer and/or social network data about said at least one second customer and said answers received from said at least one second customer;
storing said second data set in the database;
calculating, by the processing device, premium rates and discounts for the at least one first customer and the at least one second customer based on analysis of said stored first and second data sets.

2. The method according to claim 1, further comprising obtaining suggestions for an additional at least one third customer from said at least one second customer.

3. The method according to claim 1, wherein said stored second data set further comprises a number of suggestions for said at least one second customer; and wherein said calculating premium rates and discounts takes into account said number of suggestions.

4. The method according to claim 1, wherein the analysis of said stored first and second data sets comprises performing optical character recognition (OCR) on the scanned and/or photographed documents used to obtain the first and second data sets; and/or performing an analysis of the social network data used to obtain the first and second data sets.

5. The method according to claim 1, further comprising offering, by the processing device, said at least one first customer a discount or some future payment in return for said at least one first customer's participation in potential insurance claims of said at least one second customer; wherein said stored first and second data sets comprise information on one or more accepted offers of discounts or future payments; and wherein the calculation of premium rates and discounts takes into account said information on the one or more accepted offers.

6. The method according to claim 1, further comprising offering, by the processing device, a person different from said at least one first customer and different from said at least one second customer a future payment in return for said person's participation in potential insurance claims of said at least one first customer or of said at least one second customer; wherein said stored first and second data sets comprise information on one or more accepted offers of future payment; and wherein the calculation of premium rates and discounts takes into account said information one the one or more accepted offers.

7. The method according to claim 6, wherein said person is already a customer and said future payment comprises a discount.

8. The method according to claim 1, further comprising offering an insurance policy to said at least one second customer.

9. The method according to claim 1, further comprising determining, by the processing device, a segmentation of said at least one second customer into different risk classes based on said stored first and second data sets and on the calculated premium rates and discounts.

10. The method according to claim 9, further comprising offering an insurance policy to said at least one second customer based on the risk class of the at least one second customer.

11. A computer system for determining premium rates and discounts for insurance customers comprising:
a device, which comprises a processing unit, a memory connected to said processing unit and a connection to the internet; and
a database connected to said device;
wherein the device is configured to:
receive, via the connection to the internet, scans and/or photographs of documents from at least one first customer, and/or obtain, via the connection to the internet, social network data about said at least one first customer, said scans and/or photographs of documents and/or said social network data being reflective of a risk profile of said at least one first customer;
provide, via the connection to the internet, an interactive questionnaire to said at least one first customer, said questionnaire concerning the risk profile of said at least one first customer, and receive one or more answers from said at least one first customer, via the connection to the internet, wherein the interactive questionnaire is automatically generated by the processing unit;
obtain, using the processing unit, a first data set being reflective of said at least one first customer's risk profile by combining and/or integrating said scans and/or photographs of documents received from said at least one first customer and/or said social network data about said at least one first customer and said answers received from said at least one first customer;
store said first data set in said database;
obtain, via the connection to the internet, suggestions for at least one second customer from said at least one first customer;
receive, via the connection to the internet, scans and/or photographs of documents from said at least one second customer and/or obtain, via the connection to the internet, social network data about said at least one second customer, said scans and/or photographs of documents and/or said social network data being reflective of a risk profile of said at least one second customer;
provide, via the connection to the internet, an interactive questionnaire to said at least one second customer, said questionnaire concerning the risk profile of said at least one second customer, and receive, via the connection to the internet, one or more answers from said at least one second customer, wherein the interactive questionnaire is automatically generated by the processing unit;
obtain, by the processing unit, a second data set being reflective of said at least one second customer's risk profile by combining and/or integrating said scans and/or photographs of documents received from said at least one second customer and/or social network data about said at least one second customer and said answers received from said at least one second customer;
store said second data in said database;
calculate premium rates and discounts for the at least one first customer and the at least one second customer based on an analysis of said stored first and second data sets by the processing unit.

12. The computer system according to claim 11, wherein the device is further configured to obtain suggestions for an additional at least one third customer from said at least one second customer.

13. The computer system according to claim 11, wherein said stored second data set further comprises a number of suggestions for said at least one second customer; and wherein said calculating premium rates and discounts takes into account said number of suggestions.

14. The computer system according to claim 11, wherein the device is further configured to offer, via said connection to the internet, said at least one first customer a discount or some future payment in return for said at least one first customer's participation in potential insurance claims of said at least one second customer; wherein said stored first and second data sets comprise information on one or more accepted offers of discounts or future payments; and wherein the calculation of premium rates and discounts takes into account said information on the one or more accepted offers.

15. The computer system according to claim 11, wherein the device is further configured to offer, via said connection to the internet, a person different from said at least one first customer and different from said at least one second customer a future payment in return for said person's participation in potential insurance claims of said at least one first customer or of said at least one second customer; wherein said stored first and second data sets comprise information on one or more accepted offers of future payment; and wherein the calculation of premium rates and discounts takes into account said information one the one or more accepted offers.

16. A memory connected to a processing unit and containing software programs configured to cause the processing unit to execute operations comprising:
receiving scans and/or photographs of documents from at least one first customer, and/or obtaining social network data about said at least one first customer, said scans and/or photographs of documents and/or said social network data being reflective of a risk profile of said at least one first customer;
providing an interactive questionnaire to said at least one first customer, said questionnaire concerning the risk profile of said at least one first customer, and receiving one or more answers from said at least one first customer;
obtaining a first data set being reflective of said at least one first customer's risk profile by combining and/or integrating said scans and/or photographs of documents received from said at least one first customer and/or said social network data about said at least one first customer and said answers received from said at least one first customer;
storing said first data set in a database;
obtaining suggestions for at least one second customer from said at least one first customer;
receiving scans and/or photographs of documents from said at least one second customer and/or obtaining social network data about said at least one second customer, said scans and/or photographs of documents and/or said social network data being reflective of a risk profile of said at least one second customer;
providing an interactive questionnaire to said at least one second customer, said questionnaire concerning the risk profile of said at least one second customer, and receiving one or more answers from said at least one second customer;
obtaining a second data set being reflective of said at least one second customer's risk profile by combining and/or integrating said scans and/or photographs of documents received from said at least one second customer and/or social network data about said at least one second customer and said answers received from said at least one second customer;
storing said second data set in the database;
calculating premium rates and discounts for the at least one first customer and the at least one second customer based on analysis of said stored first and second data sets.

17. The memory according to claim 16, wherein the operations further comprise obtaining suggestions for an additional at least one third customer from said at least one second customer.

18. The memory according to claim 16, wherein said stored second data set further comprises a number of suggestions for said at least one second customer; and wherein said calculating premium rates and discounts takes into account said number of suggestions.

19. The memory according to claim 16, wherein the operations further comprise offering said at least one first customer a discount or some future payment in return for said at least one first customer's participation in potential insurance claims of said at least one second customer; wherein said stored first and second data sets comprise information on one or more accepted offers of discounts or future payments; and wherein the calculation of premium rates and discounts takes into account said information on the one or more accepted offers.

20. The method according to claim 16, wherein the operations further comprise offering a person different from said at least one first customer and different from said at least one second customer a future payment in return for said person's participation in potential insurance claims of said at least one first customer or of said at least one second customer; wherein said stored first and second data sets comprise information on one or more accepted offers of future payment; and wherein the calculation of premium rates and discounts takes into account said information one the one or more accepted offers.
